(19) United States
(12) Patent Application Publication
(10) Pub. No.: US 2006/0286474 A1
(43) Pub. Date: Dec. 21, 2006

(54) Electrophotographic photosensive element and image forming device provided with it

(76) Inventors: Tatsuhiro Morita, Nara (JP); Shinya Mimura, Nara (JP); Katsuya Takano, Nara (JP)

Correspondence Address: NIXON & VANDERHYE, PC, 901 NORTH GLEBE ROAD, 11TH FLOOR, ARLINGTON, VA, 22203, US

(21) Appl. No.: 10/557,254

(22) PCT Filed: May 12, 2004
(86) PCT No.: PCT/JP04/06386

§ 371 Date: Nov. 16, 2005

(30) Foreign Application Priority Data
May 16, 2003 (JP) 2003-139079

(51) Int. Cl. G03G 5/047

(52) U.S. Cl. 430/59.5; 430/78

(57) ABSTRACT

An electrophotographic photoreceptor which is excellent in the cleaning property and does not deteriorates the image quality for the formed images during long time use, and capable of forming images at high sensitivity, high resolution and high image quality, is provided. A photosensitive layer provided on a conductive substrate of an electrophotographic photoreceptor contains an oxotitanium phthalocyanine of a crystal form showing a diffraction peak at least at 27.3° in view of the Bragg angle 2θ in the X-ray diffraction spectrum and a surface free energy (γ) on a surface thereof is set to range from no less than 20 mN/m to no more than 35 mN/m. Such a inclusion of the oxotitanium phthalocyanine of specified crystal form enables formation of an image excellent in sensitivity and resolution and the control of a foreign matter depositing force when γ is set to an appropriate range, thus delivering a good cleaning performance.

### TECHNICAL FIELD

The present invention concerns an electrophotographic photoreceptor and an image forming apparatus having the same for use in an electrophotographic image forming apparatus, for example, a copying machine.

### BACKGROUND ART

An electrophotographic image forming apparatus has found wide acceptance in not only a copying machine but also a printer, an output device of a computer which has been increasingly demanded in recent years. In the electrophotographic image forming apparatus, a photosensitive layer of an electrophotographic photoreceptor installed in the apparatus is uniformly charged with a charging unit, exposed to, for example, a laser beam corresponding to image information, and a fine-grain developer called a toner is supplied to an electrostatic latent image formed by the exposure from a developing unit to form a toner image.

The toner image formed by a developer-component toner attaching on the surface of an electrophotographic photoreceptor is transferred by transfer means to a transfer material such as recording paper. However, the toner on the surface of the electrophotographic photoreceptor is not entirely moved to the recording paper through transfer as such but is partially left on the surface of the electrophotographic photoreceptor. Further, paper dust of recording paper in contact with the electrophotographic photoreceptor upon development may sometimes remain while being deposited to the electrophotographic photoreceptor.

Since the remaining toner and the deposited paper dust on the surface of the electrophotographic photoreceptor give undesired effects on the quality of formed images, they are removed by a cleaning device, or by a so-called development and cleaning system of recovering the residual toner by a cleaning function added to the developing means not having independent cleaning means in recent years as the cleanerless technique has been proceeded. As described above, since the operations of charging, exposure, development, transfer, cleaning and charge elimination have been conducted repetitively to the electrophotographic photoreceptor, durability to electrical and mechanical external forces is demanded. Specifically, it has been demanded for durability against occurrence of wear or injury caused by friction of the surface of the electrophotographic photoreceptor, or degradation to the surface layer caused by deposition of active substances such as ozone and NOx generated by the charging device during charging.

For attaining cost reduction and saving maintenance in the electrophotographic image forming apparatus, it is important that the electrophotographic photoreceptor has a sufficient durability and can operate stably for a long time. One of the factors that has effects on the durability and the long time stability of the operation is a cleaning property of the surface, that is, easy cleanability, and easy cleanability is concerned with the surface state of the electrophotographic photoreceptor.

Cleaning of the electrophotographic photoreceptor is to eliminate any remaining toner particles, paper dust and the like with a force acting thereon from the surface of the electrophotographic photoreceptor. The force is the one exceeding the attachment strength between the surface of the electrophotographic photoreceptor and the remaining toner particles attached thereon. Accordingly, the lower the wettability of the surface of the electrophotographic photoreceptor, the easier the cleaning. The wettability, namely, the adhesion of the surface of the electrophotographic photoreceptor can be expressed using a surface free energy (which has the same meaning as a surface tension) as an index.

The surface free energy (γ) is a phenomenon which an intermolecular force, a force acting between molecules constituting a substance, causes on the outermost surface.

A toner that remains on the surface of the electrophotographic photoreceptor by adhesion or fusion without being transferred onto a transfer member is spread on the surface of the electrophotographic photoreceptor in the form of a film while steps from charging to cleaning are repeated. This phenomenon corresponds to “adhesion wettability” in the wettability. Further, paper dust, rosin, talc and the like are adhered to the electrophotographic photoreceptor of which contact areas therewith increase afterward, and become intensely wet. This phenomenon also corresponds to “adhesion wettability”.

FIG. 6 is a side view showing a state of adhesion wettability. In the adhesion wettability shown in FIG. 6, the relation between the wettability and the surface free energy (γ) is represented by Young's formula (1).
γ₁=γ₂·cos θ+γ₁₂ (1)

wherein
γ₁: surface free energy on a surface of product 1
γ₂: surface free energy on a surface of product 2
γ₁₂: interface free energy of products 1 and 2
θ: contact angle of product 2 to product 1

In formula (1), reduction in wettability of product 2 to product 1 which means that θ is increased for less wetting is attained by increasing the interface free energy γ₁₂ related with a wetting work of the electrophotographic photoreceptor and the foreign matters and decreasing the surface free energies γ₁ and γ₂.

When adhesion of foreign matters, moisture, and the like to the surface of the electrophotographic photoreceptor is considered in formula (1), product 1 corresponds to the electrophotographic photoreceptor and product 2 to a foreign matters respectively. Accordingly, when the electrophotographic photoreceptor is actually cleaned, the wettability on the right side of formula (1), namely, the adhered condition of the toner, paper dust and the like as foreign matters to the electrophotographic photoreceptor can be controlled by controlling the surface free energy γ₁ of the electrophotographic photoreceptor.

In the prior technique that defines a surface condition of an electrophotographic photoreceptor, a contact angle with pure water is used (refer to, for example, Japanese Unexamined Patent Publication JP-A 60-22131 (1985)). However, in regard to wetting of a solid and a liquid, the contact angle θ can be measured as shown in FIG. 6, but in case of a solid and a solid such as an electrophotographic photoreceptor and a toner, paper dust and the like, the contact angle θ cannot be measured. Accordingly, the foregoing prior technique can be applied to wettability between a surface of an electrophotographic photoreceptor and pure water, but a relation between wettability and cleanability of a solid such as a toner of developer, paper dust and the like cannot be explained satisfactorily.

With respect to an interface free energy between a solid and a solid which is deemed necessary for evaluation of a wettability between a solid and a solid, the Forkes's theory stating a non-polar intermolecular force is considered to be further extended to a component formed by a polar or hydrogen-bonding intermolecular force (refer to Kitazaki T., Hata T., et al.; “Extension of Forkes's Formula and Evaluation of Surface Tension of Polymeric Solid”, Nippon Secchaku Kyokaishi, Nippon Secchaku Kyokai, 1972, vol. 8, No. 3, pp. 131-141). According to this extended Forkes's theory, the surface free energy of each product is found from 2 to 3 components. The surface free energy in the adhesion wettability corresponding to the adhesion of the toner or paper dust to the surface of the electrophotographic photoreceptor can be found from 3 components.

The surface free energy between solid products is described below. In the extended Forkes's theory, an addition rule of the surface free energy represented by formula (2) is assumed to be established.
γ=γ^{d}+γ^{p}+γ^{h} (2)

wherein
γ^{d}: dipolar component (polar wettability)
γ^{p}: dispersion component (non-polar wettability)
γ^{h}: hydrogen-bonding component (hydrogen-bonding wettability)

When the addition rule of formula (2) is applied to the Forkes's theory, the interface free energy γ₁₂ between product 1 and product 2 which are both solids is obtained as shown in formula (3).
γ₁₂=γ₁+γ₂−{2√(γ₁^{d}·γ₂^{d})+2√(γ₁^{p}·γ₂^{p})+2√(γ₁^{h}·γ₂^{h})} (3)

wherein
γ₁: surface free energy of product 1
γ₂: surface free energy of product 2 γ₁^{d}, γ₂^{d}: dipolar components of product 1 and product 2
γ₁^{p}, γ₂^{p}: dispersion components of product 1 and product 2
γ₁^{h}, γ₂^{h}: hydrogen-bonding components of product 1 and product 2

The surface free energies (γ^{d}, γ^{p}, γ^{h}) of the components in the solid products to be measured as represented by formula (2) can be calculated by using known reagents and measuring adhesion with the reagents. Accordingly, with respect to product 1 and product 2, it is possible that the surface free energies of the components are found and the interface free energy of product 1 and product 2 can be found from the surface free energies of the components using formula (3).

Based on the concept of the surface free energy between solid and solid thus determined, another prior art conducts control for the wettability between the surface of the electrophotographic photoreceptor and the toner or the like with the surface free energy of the electrophotographic photoreceptor being as an index (refer to JP-A No. 11-311875). Another prior art discloses to improve the cleaning property for the surface of the electrophotographic photoreceptor and attain longer life by defining the surface free energy to a range from 35 to 65 mN/m.

However, the inventors of the present invention use the electrophotographic photoreceptor having the surface free energy within the range disclosed in another related art to conduct an actual performance test by actually forming an image with respect to a recording paper. As a result of such a test study, the surface of the electrophotographic photoreceptor is observed with flaws that are possibly resulted from exposure to foreign substances such as paper powder. Also observed on the image transferred to the recording paper are black streaks resulted from poor cleaning due to those flaws. The flaws caused to the surface of the electrophotographic photoreceptor described above tend to become remarkable along with increase of the surface free energy.

In further another related art, an amount (Δγ) of change in surface free energy according to duration of an electrophotographic photoreceptor is defined. However, in consideration of the facts that the amount (Δγ) of change is not determined by defining initial characteristics, for example, the surface free energy, of the electrophotographic photoreceptor and the amount (Δγ) of change varies depending on conditions such as an environment in image formation and a material of a transfer member, the amount (Δγ) of change is problematic in that it might include an uncertain element and is therefore inappropriate as a designing standard in actual designing of an electrophotographic photoreceptor.

Further, in the electrophotographic image forming apparatus in recent years, digitalization capable of forming images at high quality, storing input images to a memory and improving the degree of freedom for edition by using a coherent laser light as an optical source has been proceeded rapidly instead of an image forming apparatus using a white light as a light source, that is, a so-called analog machine. In the formation of digital images, when image information inputted from a computer are used directly, electrical signals are converted into light signals or, when image information inputted from an original document are used, the image information of the original document are read as light information, it was then once converted into digital electrical signals, converted again into light signals and inputted to a photoreceptor. For the light inputted as light signals digitalized from the image information to the photoreceptor, a laser light or light emitting diode (LED) light is mainly used. Those used most frequently at present in laser light and the LED light are near infrared light at an oscillation wavelength of 780 nm or 660 nm, or a light at a long wavelength approximate thereto.

The characteristic required at first for the electrophotographic photoreceptor used for digital image information is that it has a good sensitivity to the long wavelength light used for the light input. For the photosensitive material of the electrophotographic photoreceptor, various materials have been studied so far and, among them, phthalocyanine compounds have been generally studied and put to practical use since most of them can be synthesized relatively simply and show the sensitivity to the long wavelength light. Phthalocyanines differ in the sensitivity peaks and physical properties depending on the absence or presence or the kind of the central metal, as well as differ greatly in the physical property due to the difference of the crystal form thereof (refer to “Dyestuffs and Chemicals”, Vol., 24, No. 6, P122 (1979) written by Manabu Sawada, Japan Dyestuff & Industrial Chemical Associations).

Accordingly, in the study of the photosensitive materials used for electrophotographic photoreceptors, it is important to conduct research and development not only on the composition but also on the crystal form, and several examples of the electrophotographic photoreceptors of selecting and using photosensitive materials having specified crystal forms have been reported. For example, there have been known an electrophotographic photoreceptor using non-metal phthalocyanine (refer to JP-A 60-86551 (1985)), an electrophotographic photoreceptor using a phthalocyanine containing aluminum (refer to Japanese Unexamined Patent Publication JP-A 63-133462 (1988)) and, in addition, an electrophotographic photoreceptor using phthalocyanines having titanium (refer to Japanese Unexamined Patent Publication JP-A 59-49544 (1984)) indium and gallium as the central metal.

In recent years, an earnest study has been made on oxotitanium phthalocyanines having high sensitivity among phthalocyanines. It has been known that the oxotitanium phthalocyanines are classified into various crystal forms depending on the difference of the diffraction angle in the X-ray diffraction spectrum (refer to Foundation and Future Trend of Electrophotographic Organic Photoreceptor, by Akiteru Fujii, in the 53th Technical Seminars of Image Society of Japan, Journal of Image Society of Japan, P94 (2002)). Referring, specifically to characteristic crystal forms of the oxotitanium phthalocyanines, there have been disclosed α-type (refer, for example, to Japanese Unexamined Patent Publication JP-A 61-217050 (1986)), A-type (refer to Japanese Unexamined Patent Publication JP-A 62-67094 (1987)), C-type (refer, for example, to Japanese Unexamined Patent Publication JP-A 63-366 (1988)), Y-type (refer, for example, to Japanese Unexamined Patent Publication JP-A 63-020365 (1988)), M-type (refer to Japanese Unexamined Patent Publication JP-A 3-54265 (1991)), M-α type (refer to Japanese Unexamined Patent Publication JP-A 3-54264 (1991)), I-type (refer to Japanese Unexamined Patent Publication JP-A 3-128973 (1991)), and I and II types (refer to Japanese Unexamined Patent Publication JP-A 62-67094 (1987)) crystals.

Among the oxotitanium phthalocyanines having various crystal forms, so-called Y-type oxotitanium phthalocyanine showing a diffraction peak at least 27.3° in view of Bragg angle 2θ in the X-ray diffraction spectrum has the highest sensitivity and shows high sensitivity particularly in a long wavelength region. The Bragg angle 2θ in the present specification means a diffraction angle 2θ satisfying the Bragg's conditions, and the error range is ±0.2° (Bragg angle 2θ±0.2°).

However, the Y-type oxotitanium phthalocyanine involves a problem that it is still insufficient in the sensitivity, poor in the potential stability to repetitive use and tends to cause background fogging that causes black spots in the white background in the electrophotographic process using the reversal development. In addition, since the chargeability is also insufficient, it involves a problem that sufficient image density is difficult to obtain.

As the prior art for solving such problems, it has been proposed a novel crystal form oxotitanium phthalocyanine showing a maximum diffraction peak at 9.4° or 9.7° and showing diffraction peaks at least at 7.3°, 9.4°, 9.7° and 27.3° in view of the Bragg angle 2θ in the X-ray diffraction spectrum, and an electrophotographic photoreceptor using the same, as well as an image forming method using the same (refer to Japanese Unexamined Patent Publication JP-A. 10-237347).

The oxotitanium phthalocyanine of the novel crystal form and the electrophotographic photoreceptor using the same proposed in Japanese Unexamined Patent Publication JP-A 10-237347 (1998) can provide images at high sensitivity and high quality when compared with the oxotitanium phthalocyanines of existent crystal forms and the electrophotographic photoreceptor using the same described above, and it is excellent in the potential stability during repetitive use and can decrease the occurrence of background fogging extremely in the electrophotographic process using the reversal development.

The electrophotographic photoreceptor used for the electrophotographic image forming apparatus should have favorable light sensitivity and also favorable cleaning property described above which is an important characteristic like the light sensitivity. While improvement in the cleaning property is essential for the improvement of the durability and in the stable image formation at high image quality for a long time in the electrophotographic photoreceptor, it has a problem that no favorable cleaning property can be attained by merely using the oxotitanium phthalocyanine of the specified crystal form described above.

### DISCLOSURE OF THE INVENTION

An object of the invention is to provide an electrophotographic photoreceptor which causes less surface flaws and does not deteriorates the image quality for the formed images during long time use, and is excellent in the cleaning property and capable of forming images at high sensitivity, high resolution and high image quality, by incorporating an oxotitanium phthalocyanine of a specified crystal form into a photosensitive layer and by controlling the surface free energy on a surface of the photosensitive layer, as well as an image forming apparatus having the same.

The invention provides an electrophotographic photoreceptor comprising a conductive substrate and a photosensitive layer provided on the conductive substrate, the photosensitive layer being uniformly charged with electric charges and exposed to light in accordance with image information to form electrostatic latent images,

wherein the photosensitive layer contains an oxotitanium phthalocyanine of a crystal form showing a diffraction peak at least at 27.3° in view of the Bragg angle 2θ in the X-ray diffraction spectrum and a surface free energy (γ) on a surface thereof ranges from no less than 20 mN/m to no more than 35 mN/m.

Further, the invention is characterized in that the surface free energy (γ) ranges from no less than 28 mN/m to no more than 35 mN/m.

In accordance with the invention, the photosensitive layer of the electrophotographic photoreceptor is defined such that it contains an oxotitanium phthalocyanine of a crystal form showing a diffraction peak at least at 27.3° in view of the Bragg angle 2θ in the X-ray diffraction spectrum and the surface free energy (γ) on the surface ranges from no less than 20 mN/m to no more than 35 mN/m, preferably, from no less than 28 mN/m to no more than 35 mN/m. The surface free energy of the electrophotographic photoreceptor referred to herein is calculated and derived by Forkes expansion theory described above.

The surface free energy on the surface of the electrophotographic photoreceptor is an index of wettability, that is, a deposition strength of a developer or paper dust to the surface of the electrophotographic photoreceptor. By setting the surface free energy within the preferred range described above, since excess deposition strength of the developer can be suppressed particularly irrespective of the onset of the deposition strength about at a level necessary for the development and the deposition strength to obstacles such as paper dust can be suppressed, excessive developer or obstacles can be removed easily from the surface of the electrophotographic photoreceptor. Thus, the cleaning property can be improved without lowering the developing performance. Accordingly, since flaws caused by obstacles deposited on the surface less occur, an electrophotographic photoreceptor excellent in the durability having long life and not causing deterioration of the quality in the formed images stably for a long time can be attained.

Further, since the oxotitanium phthalocyanine of the crystal form contained in the photosensitive layer and showing the diffraction peak at least at 27.3° in view of the Bragg angle 2θ in the X-ray diffraction spectrum has an extremely high charge generating performance to a near infrared light at 780 nm or 660 nm as an oscillation wavelength of light of a laser or an LED serving as optical input means suitable for formation of digital images, or for long wavelength light approximate thereto, an electrophotographic photoreceptor of high sensitivity, high resolution and high quality can be attained. According to the invention, as described above, it is possible to provide an electrophotographic photoreceptor capable of satisfying both the cleaning property and high sensitivity characteristic.

Further, the invention is characterized in that the oxotitanium phthalocyanine is an oxotitanium phthalocyanine of a crystal form showing the maximum diffraction peak at 9.4° or 9.7° and having diffraction peaks at least at 7.3°, 9.4°, 9.7°, and 27.3° in view of the Bragg angle 2θ in the X-ray diffraction spectrum.

In accordance with the invention, by using an oxotitanium phthalocyanine of a crystal form showing the maximum diffraction peak at 9.4° or 9.7° and having diffraction peaks at least at 7.3°, 9.4°, 9.7°, and 27.3° in view of the Bragg angle 2θ in the X-ray diffraction spectrum to an electrophotographic photoreceptor, the sensitivity can be increased and images at high quality can be provided. Further, it is possible to obtain an electrophotographic photoreceptor excellent in the potential stability to repetitive use, with extremely less occurrence of background fogging or the like in the electrophotographic process using reversal development, and having remarkably high sensitivity in the long wavelength region and high durability.

Further, the invention is characterized in that the photosensitive layer is formed by laminating a charge generating layer containing a charge generating substance and a charge transporting layer containing a charge transporting substance.

In accordance with the invention, the photosensitive layer of the electrophotographic photoreceptors formed by laminating a charge generating layer containing a charge generating substance and a charge transporting layer containing a charge transporting substance. Since the degree of freedom for material constituting each of the layers and the combination thereof is increased by forming the photosensitive layer as such a type that plural layers are laminated, the value for the surface free energy on the surface of the electrophotographic photoreceptor can be easily set within a desired range.

Further, the invention provides an image forming apparatus comprising any one of the electrophotographic photoreceptors described above.

In accordance with the invention, the image forming apparatus comprises an electrophotographic photoreceptor excellent in the cleaning property and having high sensitivity. Accordingly, an image forming apparatus capable of forming images with no degradation of image quality for a long time stably and at a reduced cost and with less maintenance frequency is provided.

### BRIEF DESCRIPTION OF DRAWINGS

Other and further objects, features, and advantages of the invention will be more explicit from the following detailed description taken with reference to the drawings wherein:

FIG. 1 is a fragmentary cross-sectional view schematically showing the constitution of an electrophotographic photoreceptor 1 according to a first embodiment of the invention;

FIG. 2 is a view showing an X-ray diffraction spectrum for an oxotitanium phthalocyanine crystal showing the maximum diffraction peak at 9.7° and showing distinct diffraction peaks at least at 7.3°, 9.4°, 9.7°, and 27.3° of the Bragg angle 2θ;

FIG. 3 is a view showing a constitution of a dip coating apparatus 10;

FIG. 4 is a fragmentary cross-sectional view schematically showing the constitution of a photoreceptor 7 according to a second embodiment of the invention;

FIG. 5 is a side elevational view for arrangement schematically showing the constitution of an image forming apparatus 30 according to a third embodiment of the invention; and

FIG. 6 is a side view showing a state of adhesion wettability.

### BEST MODE FOR CARRYING OUT THE INVENTION

Now referring to the drawings, preferred embodiments of the invention are described below.

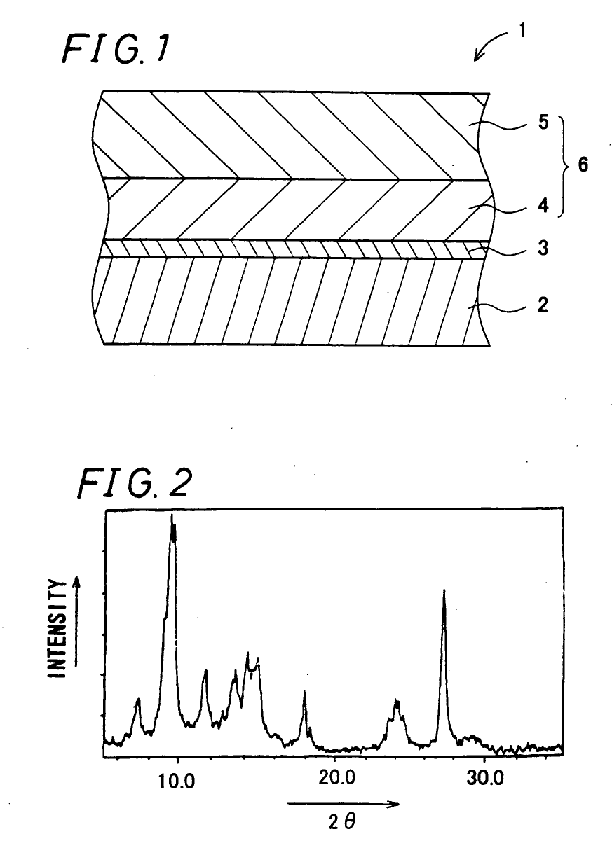

FIG. 1 is a fragmentary cross-sectional view schematically showing the constitution of an electrophotographic photoreceptor 1 according to a first embodiment of the invention. The electrophotographic photoreceptor 1 (hereinafter, simply referred to as photoreceptor) of the embodiment according to the invention comprises a conductive substrate 32 made of a conductive material, an undercoat layer 3 that is overlaid on the conductive substrate 32, a charge generating layer 4 that is overlaid on the undercoat layer 3 and includes a charge generating substance, and a charge transporting layer 5 that is overlaid on the charge generating layer 4 and includes a charge transporting substance. The charge generating layer 4 and the charge transporting layer 5 configure a photosensitive layer 6.

The conductive substrate 2 has a cylindrical shape for which (a) a metal material and an alloy material such as aluminum, copper, brass, zinc, nickel, stainless steel, chromium, molybdenum, vanadium, indium, titanium, gold, and platinum, (b) a polyester film, paper tube or metal film vapor deposited or coated with aluminum, aluminum alloy, tin oxide, gold, indium oxide, etc., and (c) plastic or paper containing conductive particles, and (d) plastics containing conductive polymers are used suitably.

The conductive substrate 2 serves as an electrode for the photoreceptor 1, as well as also functions as a support member for each of other layers 3, 4 and 5. The shape of the conductive substrate 2 is not restricted to the cylindrical shape but may be any of cylindrical, plate, film or belt shape.

The undercoat layer 3 is provided between the conductive substrate 2 and the photosensitive layer 6 upon forming the photosensitive layer 6 over the conductive substrate 2 with a reason, for example, of covering flaws and unevenness on the surface of the conductive substrate 2, preventing degradation of the chargeability during repetitive use and improvement for the charging property under a low temperature/low humidity circumstance. For forming the undercoat layer 3, known polyamide, copolymerized nylon, polyvinyl alcohol, polyurethane, polyester, epoxy resin, phenol resin, casein, cellulose, gelatin, etc. are used and, particularly, alcohol soluble copolymerized nylon is used suitably.

A coating solution for undercoat layer is prepared by dispersing the material for forming the undercoat layer described above in water and various organic solvents, particularly, a single solvent of water, methanol, ethanol, or butanol, or various kinds of mixed solvents. The various kinds of mixed solvents include mixed solvents of water and alcohols, mixed solvents of two or more kinds of alcohols, mixed solvents of acetone or dioxolane with alcohols, mixed solvents of chloro-solvents such as dichloroethane, chloroform, and trichloroethane with alcohols.

Further, the coating solution for undercoat layer may also be optionally incorporated with an inorganic pigment such as zinc oxide, titanium oxide, tin oxide, indium oxide, silica and antimony oxide by dispersion using a dispersing machine such as a ball mill, DYNO-MILL, supersonic oscillation device, etc. with an aim of controlling the volumic resistivity and the improvement of the repetitive aging characteristic under the low temperature/low humidity circumstance for the undercoat layer 3. The content of the inorganic pigment in the undercoat layer 3 is preferably within a range from 30 to 95% by weight. The undercoat layer 3 is coated such that the film thickness is about 0.1 to 5 μm after drying.

The charge generating layer 4 is formed by dipping and coating a coating solution for charge generating layer on the undercoat layer 3. The coating solution for charge generating layer comprises a charge generating substance that generates charges under irradiation of light as a main ingredient and optionally contains known binder resin, plasticizer and sensitizer. In this embodiment, the invention is characterized by containing, as the charge generating substance, an oxotitanium phthalocyanine showing a distinct diffraction peak at 27.3° of the Bragg angle 2θ in the X-ray diffraction spectrum and, particularly, an oxotitanium phthalocyanine crystals showing the maximum diffraction peak at 9.4° or 9.7° and showing distinct diffraction peaks at least at 7.3°, 9.4°, 9.7°, and 27.3° as the charge generating substance.

FIG. 2 is a view showing an X-ray diffraction spectrum for an oxotitanium phthalocyanine crystal showing the maximum diffraction peak at 9.7° and showing distinct diffraction peaks at least at 7.3°, 9.4°, 9.7°, and 27.3° of the Bragg angle 2θ. The photoreceptor 1 containing a specified crystal form of oxotitanium phthalocyanine as shown in FIG. 2 can provide images at high sensitivity and high quality, is excellent in the potential stability to repetitive use and can extremely decrease the occurrence of background fogging, etc. in the electrophotographic process using reversal development.

The oxotitanium phthalocyanine having the specified crystal form described above may be used also in combination with other charge generating substances, for example, a phthalocyanine pigment having a crystal form different from the oxotitanium phthalocyanine having the specified crystal form described above, azo pigments, perylene pigments such as perylene imide and perylenic acid anhydride, polynuclear quinone pigments such as quinacridone, anthraquinone, squarylium dye, azulenium dye, thiapyrylium dye.

The phthalocyanine pigment having a crystal form different from the oxotitanium phthalocyanine having the specified crystal form includes α-type, β-type Y-type, or amorphous oxotitanium phthalocyanine-containing metal phthalocyanines, non-metal phthalocyanines, and halogenated non-metal phthalocyanines. Further, the azo pigment includes azo pigments containing a carbazole skeleton, styryl stylbene skeleton, triphenyl amine skeleton, dibenzothiophene skeleton, oxadiazole skeleton, fluolenone skeleton, bisstylbene skeleton, distyryl oxadiazole skeleton, or distyryl carbazole skeleton.

The pigment having particularly high charge generating performance includes non-metal phthalocyanine pigments, oxotitanium phthalocyanine pigments, gallium (chloro)phthalocyanine pigments, mixed crystals of metal phthalocyanine and non-metal phthalocyanine, bisazo pigment containing fluolene ring or fluolenone ring, bisazo pigment and trisazo pigment comprising an aromatic amine. A photoreceptor having high sensitivity can be obtained by using such pigments.

Combined use of the oxotitanium phthalocyanine having the specified crystal form and other charge generating substance is advantageous since this enables to control the exposure amount-sensitivity characteristic of the photoreceptor to an optional light attenuation curve and extend the degree of freedom in the design of the image forming process.

The binder resin includes, for example, melamine resin, epoxy resin, silicone resin, polyurethane resin, acryl resin, vinyl chloride-vinyl acetate copolymer resin, vinyl chloride-vinyl acetate-maleic acid anhydride copolymer resin, vinyl chloride-vinyl acetate-polyvinyl alcohol copolymer resin, polycarbonate resin, phenoxy resin, phenol resin, polyvinyl butyral resin, polyarylate resin, polyamide resin, and polyester resin. As the solvent for dissolving the resins described above, ketones such as acetone, methyl ethyl ketone, and cyclohexanone, esters such as ethyl acetate and butyl acetate, ethers such as tetrahydrofuran, dioxane, dioxolane, and dimethoxyethane, aromatic hydrocarbons such as benzene, toluene, and xylene and aprotic polar solvent such as N,N-dimethyl formamide, and dimethyl sulfoxide can be used.

As the coating solution for charge generating layer, those comprising oxotitanium phthalocyanine crystals having the specified crystal form described above, the butyral resin as a binder resin, silicone oil and a mixed solvent of two or more kinds of organic non-halogeno solvents are preferred. For the mixed solvent, a mixed solvent of dimethoxyethane and cyclohexanone is most preferred.

As a method of forming the charge generating layer, while there is a method of forming a compound as a charge generating substance directly into a film by vapor deposition and a method of forming a film by coating a coating solution in which a charge generating substance is dispersed in a binder resin solution, the latter method is generally preferred and a dip-coating method to be described later is used in this embodiment. For the method of mixing and dispersing the charge generating substance in the binder resin solution and the coating method of the coating solution for charge generating layer, the same method as in the undercoat layer 3 is used. The ratio of the charge generating substance in the charge generating layer is preferably within a range from 30 to 90% by weight. The thickness of the charge generating layer is, preferably, from 0.05 to 5 μm and, more preferably, from 0.1 to 1.5 μm.

The charge transporting layer 5 is disposed over the charge generating layer 4. The charge transporting layer 5 can contain a charge transporting substance having an ability of accepting charges generated from the charge generating substance and transporting them, a binder resin, and, optionally, known plasticizer, sensitizer, etc.

The charge transporting substance includes electron donating substances such as poly-N-vinyl carbazole and derivatives thereof, poly-γ-carbazolyl ethyl glutamate and derivatives thereof, pyrene-formaldehyde condensation product and derivatives thereof, polyvinyl pyrene, polyvinyl phenanthrene, oxazole derivatives, oxadiazole derivatives, imidazole derivatives, 9-(p-diethylamino styryl)anthracene, 1,1-bis(4-dibenzylaminophenyl)propane, styryl anthracene, styrylpirazolin, pirazolin derivatives, phenyl hydrozones, hydrazone derivatives, triphenyl amine compounds, triphenyl methane compounds, stylbene compounds, and azine compounds having 3-methyl-2-benzothiazoline ring. Further, it includes electron accepting substances such as fluorenone derivatives, dibenzothiophene derivatives, indenothiophene derivatives, phenanthrene quinone derivatives, indenopiridine derivatives, thioxanthone derivatives, benzo[c]cinnoline derivatives, phenadine oxide derivatives, tetracyano ethylene, tetracyanoquinodimethane, bromanil, chloranil and benzoquinone.

The binder resin constituting the charge transporting layer 5 may be any of those having compatibility with the charge transporting substance and includes, for example, polycarbonate, and copolymerized polycarbonate, polyarylate, polyvinyl butyral, polyamide, polyester, epoxy resin, polyurethane, polyketone, polyvinyl ketone, polystyrene, polyacrylamide, phenol resin, phenoxy resin, polysulfone resin, and copolymer resins thereof. They may be used alone or two or more of them may be used in admixture. Among them, resins such as polystyrene, polycarbonate, copolymerized polycarbonate, polyarylate, and polyester have a volumic resistivity of 10¹³ Ω or more and are also excellent in the film forming property and the potential characteristic.

As the solvent for dissolving the binder resin, alcohols such as methanol and ethanol, ketones such as acetone, methyl ethyl ketone, and cyclohexanone, ethers such as ethylether, tetrahydrofuran, dioxane, and dioxolane, aliphatic halogeno hydrocarbons such as chloroform, dichloromethane, and dichloroethane, and aromatics such as benzene, chlorobenzene, toluene can be used.

The coating solution for charge transporting layer is prepared by dissolving a charge transporting substance in a binder resin solution. The ratio of the charge transporting substance in the charge transporting layer 5 is preferably within a range from 30 to 80% by weight. For the method of mixing and dispersing the charge transporting substance in the binder resin solution and the coating method of the coating solution for charge transporting layer, the same method as for the undercoat layer 3 is used. The thickness of the charge transporting layer 5 is, preferably, 10 to 50 μm and more preferably, 15 to 40 μm.

While this embodiment has a constitution of forming the charge transporting layer over the charge generating layer, it is not limitative but may have a constituting of forming the charge generating layer over the charge transporting layer.

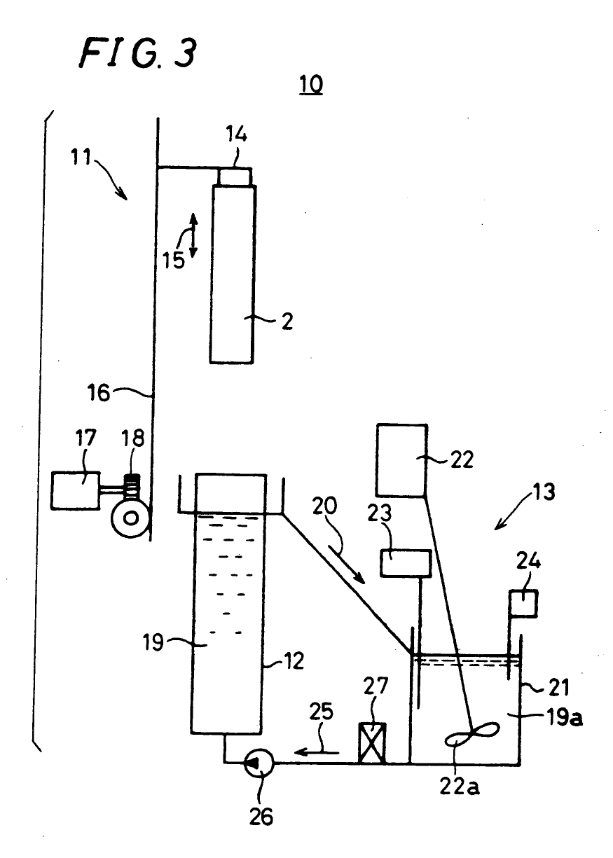

In this embodiment, each of the layer 3, 4, and 5 laminated over the conductive substrate 2 is coated and formed by the dip-coating method. The dip-coating method is to be described below. The dip coating method is a method of forming a layer of a photoreceptor by dipping a cylindrical conductive substrate or a cylindrical conductive substrate formed with an undercoat layer or the like in a coating tank filled with a coating solution for undercoat layer or the coating solution containing the photosensitive material and then pulling-up the same at the constant speed or at an optionally changing speed. Since the dip coating method is relatively simple and excellent in view of the productivity and the cost, it has often been utilized for the manufacture of photoreceptors. FIG. 3 is a view showing a constitution of a dip coating apparatus 10. The dip coating in a case of forming the undercoat layer 3 is to be illustrated, for example, with reference to FIG. 3.

The dip coating apparatus 10 generally includes elevation means 11, a coating tank 12, and coating solution supply means 13. The elevation means 11 includes a chucking portion 14 for chucking the conductive substrate 2, a driving member 16 for vertically driving the chucking portion 14 in the direction of an arrow 15, a motor 17 as a driving source, and a gearing portion 18 for transmitting the driving force of the motor 17 to the driving member 16. The driving member 16 is embodied, for example, by a ball screw. When the conductive substrate 2 is chucked by a chucking portion 14 and the amount of rotation of the motor 17 is controlled, the conductive substrate 2 can be moved by a desired distance in the direction of the arrow 15.

The coating tank 12 is a hollow container made of a metal or synthetic resin and a coating solution 19 for undercoat layer is contained in the inner space thereof. The coating solution contained in the coating tank 12 is not restricted to the coating solution for undercoat layer but a coating solution for charge generating layer is contained during formation of the charge generating layer, and a coating solution for charge transporting layer is contained during formation of the charge transporting layer.

The coating solution supply means 13 includes an auxiliary tank 21 for recovering the coating solution overflowing from the coating layer 12 in the direction of an arrow 20, a stirring device 22 for stirring the coating solution 19a in the auxiliary tank 21 by a stirring blade 22a, a viscosity measuring instrument 23 for measuring the viscosity of the coating solution 19a in the auxiliary tank 21, a solvent adding device 24 for adding a solvent to control the viscosity of the coating solution 19a in the auxiliary tank 21, a pump 26 for supplying the coating solution 19a in the auxiliary tank 21 in the direction of an arrow 25, that is, to the coating tank 12, and a filter 27 disposed in the midway of the supply tube for the coating solution 19a.

The conductive substrate 2 closely held at the upper end by the chucking portion 14 is lowered by the elevation means 11 and dipped into the coating solution 19 contained in the coating tank 12. After the conductive substrate 2 is dipped sufficiently, the chucking portion 14 is elevated by the elevation means 11 and the conductive substrate 2 is pulled up from the coating solution 19. It is not restricted to the constitution of vertically moving the conductive substrate 2 but it may be structured such that the coating tank 12 is moved vertically.

When the conductive substrate 2 is dipped into the coating solution 19 contained in the coating tank 12, the coating solution overflowing from the coating tank 12 flows in the direction of the arrow 20 and is recovered in the auxiliary tank 21. In the auxiliary tank 21, the addition amount of the solvent is controlled by the solvent addition device 24 while measuring the viscosity of the coating solution 19a so that it is constant by a viscosity measuring instrument 23, and the solution is stirred by the stirring device 22. The coating solution 19a in the auxiliary tank 21 is filtered with obstacles in the solution through the filter 27 and then returned by the pump 26 to the coating tank 12 and used for dip coating.

The undercoat layer 3, the charge generating layer 4, and the charge transporting layer 5 are dried after they are formed successively by coating or on every coating and formation of each layer by the dip coating method as described above by using a hot blow or infrared or like other dryer to complete the layer formation of the photoreceptor 1. The drying condition is preferably about at 4° C. to 130° C. for 10 min to 2 hours.

In a case of using the coating solution for charge generating layer as the pigment dispersed coating solution in the dip coating apparatus 10, a coating solution dispersing apparatus typically represented by a supersonic wave generating apparatus may also be provided in order to stabilize the dispersibility of the coating solution.

Further, one or more kinds of electron accepting substances or dyes may be incorporated to the photosensitive layer 6 comprising the charge generating layer 4 and the charge transporting layer 5 thereby improving the sensitivity and suppressing the increase of residual potential or fatigue during repetitive use. The electron accepting substance includes, for example, acid anhydrides such as succinic acid anhydride, maleic acid anhydride, phthalic acid anhydride and 4-chlornaphthalic acid anhydride, cyano compounds such as tetracyano ethylene and terephthal marondinitrile, aldehydes such as 4-nitrobenzaldehydes, anthraquinones such as anthraquinone and 1-nitroanthraquinone, polynuclear or heterocyclic nitro compounds such as 2,4,7-trinitrofluolenone and 2,4,5,7-tetranitrofluolenone, and they may be used as the chemical sensitizer.

The dye includes, for example, organic photoconductive compounds such as xanthene dyes, thiazine dyes, triphenyl methane dyes, quinoline pigments and copper phthalocyanines, and they can be used as the optical sensitizer.

Well-known plasticizers may be incorporated in the photosensitive layer 6 thereby improving the moldability, flexibility and mechanical strength. The plasticizer includes, for example, dibasic acid ester, fatty acid ester, phosphoric acid ester, phthalic acid ester, chlorinated paraffin, and epoxy-type plasticizer. Further, the photosensitive layer 6 may also contain optionally for example a leveling agent for preventing orange peel such as polysiloxane, phenol compounds, hindered amine compounds, hydroquinone compounds, tocopherol compounds, paraphenylene diamine, aryl alkanes and derivatives thereof, antioxidants such as amine compounds, organic sulfur compounds and organic phosphoric compounds, and UV-ray absorbents.

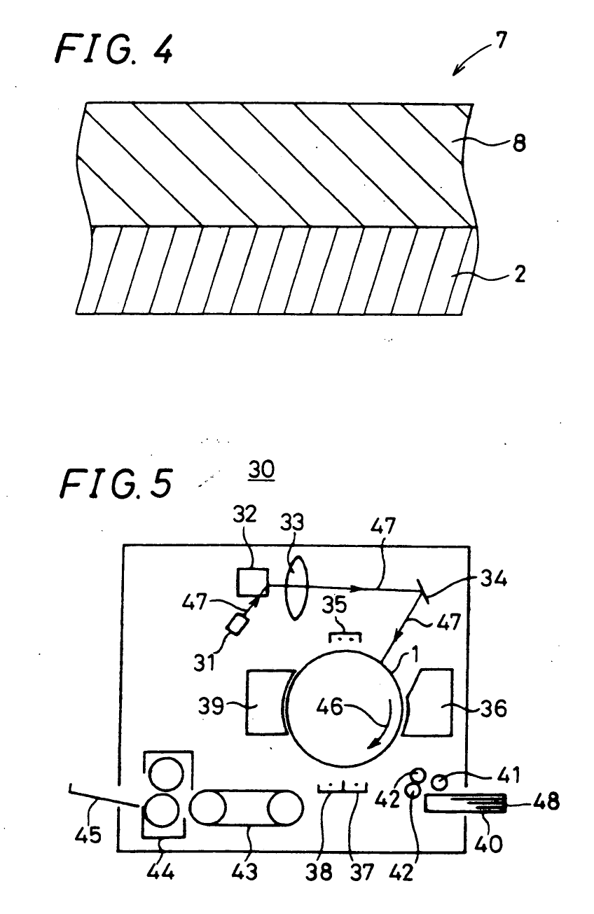

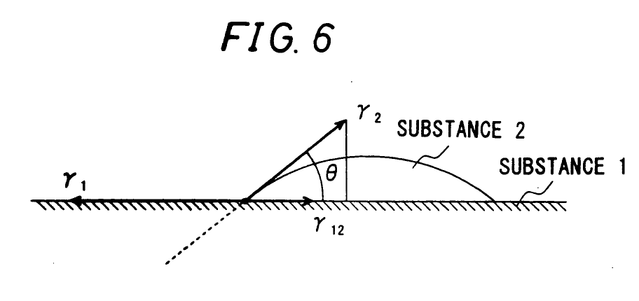

FIG. 4 is a fragmentary cross-sectional view schematically showing the constitution of a photoreceptor 7 according to a second embodiment of the invention. The photoreceptor 7 in this embodiment is similar with the photoreceptor 1 in the first embodiment, so that corresponding portions will be denoted by the same reference numerals and descriptions thereof will be omitted. What is to be noted in the photoreceptor 7 is that a photosensitive layer 8 comprising a single layer is formed over the conductive substrate 2. The photosensitive layer 8 constituting the single layered photoreceptor 7 includes a photosensitive layer in which a charge generating substances dispersed in the binder resin identical with that in the first embodiment, a photosensitive layer in which the charge generating substance is dispersed in the form of pigment particles in the charge transporting layer containing the charge transporting substance, on the photoconductive substrate 2.

The amount of the charge generating substance dispersed in the photosensitive layer 8, is preferably, from 0.5 to 50% by weight and, more preferably, from 1 to 20% by weight. The thickness of the photosensitive layer 8 is, preferably, from 5 to 50 μm and more preferably, from 10 to 40 μm. Also in the case of the single layered type photoreceptor 7, like the laminated type photoreceptor 1 of the first embodiment, known plasticizer for improving the film forming property, flexibility, mechanical strength, etc. additives for suppressing the residual potential, a dispersion aid for improving the dispersion stability, leveling agent for improving the coatability, the surfactant and other additives may also be added.

The single layered type photoreceptor 7 of this embodiment is suitable as a photoreceptor for use in a positive charging type image forming apparatus with less generation of ozone and, since the photosensitive layer 8 to be coated only consists of a single layer, it is excellent in view of the production cost and the yield compared with the laminated type photoreceptor 1. In any of the laminated type photoreceptor 1 and the single layered type photoreceptor 7, it is preferred to use a non-halogeno type, particularly, non-chloro type organic solvent, among them, for the solvent of the coating solution used for forming each of the layer in view of the global environment and with a safety and sanitary point for view of the operation. However, this does not mean that the solvent for the coating solution is restricted to the non-halogeno type solvent.

The feature of the photoreceptor 1, 7 of the embodiment according to the invention obtained as described above is that the maximal value in the sensitivity wavelength region is present near 800 nm, and therefore it has a light sensitive wavelength region optional to a light in the long wavelength region, particularly, of semiconductor laser and LED. Further, since the oxotitanium phthalocyanine of the specified crystal form used as the charge generating substance is excellent in the crystal stability to solvent, heat, and mechanical strains and the crystal form is extremely stable, the photoreceptor containing the oxotitanium phthalocyanine of the specified crystal form has a feature excellent in the sensitivity, chargeability and potential stability.

Further, the surface free energy (γ) on the surface of the photoreceptor 1, 7, that is, the photosensitive layer 6, 8 is controlled and set such that the value calculated according to the expanded Forkes theory is 20 mN/m or more and 35 mN/m or less and, preferably, 28 mN/m or more and 35 mN/m or less.

In a case where the surface free energy is less than 20 mN/m, disadvantage due to the decrease of the deposition strength of the toner, or the like to the photoreceptor is remarkable. One of the disadvantages is that the transfer ratio is increased along with the decrease of the deposition strength of the toner or the like for the photoreceptor to thereby decrease the residual toner directed to the cleaning blade. As a result, turning of the blade or the blade skip mark to the photoreceptor occurs to result in degradation of the image quality. Further, since toner scattering is promoted along with decrease of the deposition strength, this results effects by the scattered toner to the surface or the rearface of the recording paper.

In a case where the surface free energy exceeds 35 mN/m, since the deposition strength of the toner, paper dust or the like to the surface of the photoreceptor increases, the surface of the photoreceptor tends to suffer from flaws and the cleaning property is worsened due to the surface flaws. Accordingly, the surface free energy is defined as 20 to 35 mN/m.

Controlling and setting of the surface free energy on the surface of the photoreceptor to the range described above will be conducted as described below. This can be attained by introducing a fluorine-base material typically represented, for example, by polytetrafluoro ethylene (simply referred to as PTFE), polysiloxane material or the like in a photosensitive layer, and by controlling the content thereof. Further, this can be attained also by changing the kind of the charge generating substance, charge transporting substance, and the binder resin contained in the photosensitive layer or the compositional ratio thereof. Further, this can also be attained by controlling the drying temperature upon forming the photosensitive layer.

The surface free energy on the surface of the photoreceptor which is controlled and set as described above is determined by using a specimen in which the dipolar component, dispersion component and the hydrogen bond component of the surface free energy are known and measuring the depositability with the reagent as described above. Specifically, by using pure water, methylene iodide and α-bromonaphthalene as the reagent, the angle of contact relative to the surface of the photoreceptor using a contact angle meter CA-X (trade name of products; manufactured by Kyowa Interface Science Co., Ltd.), the free energy for each of the ingredients can be calculated based on the result of measurement by using a surface free energy analysis software (EG-11) (trade name of products; manufactured by Kyowa Interface Science Co., Ltd) The reagent is not restricted to pure water, methylene iodide, and α-bromonaphthalene but a reagent having an appropriate combination for the dipolar component, dispersion component, and hydrogen bonding component may also be used. Further, also the measuring method is not restricted to the method described above but, for example, a Wilhelmy method (suspended plate method) or Du Nouy method may also be used.

FIG. 5 is a side elevational view for arrangement schematically showing the constitution of an image forming apparatus 30 according to a third embodiment of the invention. The image forming apparatus 30 shown in FIG. 5 is a laser printer mounting the photoreceptor 1 according to the first embodiment of the invention. The constitution and the image forming operation of the laser printer 30 are to be described below with reference to FIG. 5. The laser printer 30 described in FIG. 5 is an example of the invention and the image forming apparatus of the invention is not restricted by the content of the following descriptions.

The laser printer 30 as an image forming apparatus includes the photoreceptor 1, a semiconductor laser 31, a rotational polygonal mirror 32, a focusing lens 33, a mirror 34, a corona charging device 35, a developing device 36, a transfer charging device 37, a separation charging device 38, a cleaner 39, a transfer paper cassette 40, paper feed roller 41, a registration roller 42, a conveying belt 43, a fixing device 44 and a paper discharge tray 45.

The photoreceptor 1 is mounted on the laser printer 30 so as to be rotatable by driving means (not shown) in a direction of an arrow 46. The surface of the photoreceptor 1 in the longitudinal direction (main scanning direction) thereof is repetitively scanned with a laser beam 47 emitted from the semiconductor laser 31 by means of the rotary polygonal mirror 32. The focusing lens 33 has f-θ characteristic and the laser beam 47 is reflected by the mirror 34 and focused to the surface of the photoreceptor 1 for exposure. By scanning the laser beam 47 as described above for focusing while rotating the photoreceptor 1, electrostatic latent images are formed on the surface of the photoreceptor 1.

The corona charging device 35, the developing device 36, a transfer charging device 37, a separation charging device 38 and a cleaning 39 are disposed in this order from the upstream to the downstream in the rotational direction of the photoreceptor 1 shown by the arrow 46. The corona charging device 35 is disposed to the upstream of the focusing point of the laser beam 47 in the rotational direction of the photoreceptor 1 to uniformly charge the surface of the photoreceptor 1. Accordingly, the laser beam 47 conducts exposure to the uniformly charged surface of the photoreceptor to result in difference between the charged amount for the area exposed by the laser beam 47 and the charged amount for the area exposed by the laser beam 47 and the charge amount for the area not exposed to form the electrostatic latent images.

The developing device 36 is disposed downstream to the focusing point of the laser beam 47 in the rotational direction, supplies a toner to the electrostatic latent images formed on the surface of the photoreceptor and develops the electrostatic latent images as toner images. The transfer paper 48 contained in the transfer paper cassette 40 is taken out one by one by the paper feed roller 41 and supplied to the transfer charging device 37 by the registration roller 42 in synchronization with exposure to the photoreceptor 1. The toner images are transferred to the transfer paper 48 by the transfer charging device 37. The separation charge 38 disposed adjacent with the transfer charging device 37 eliminates charges from the transfer paper to which the toner images are formed to separate it from the photoreceptor 1.

The transfer paper 48 separated from the photoreceptor 1 is conveyed by the conveyor belt 43 to the fixing device 44 where the toner images are fixed by the fixing device 44. The transfer paper 48 thus formed with images is discharged toward a paper discharge tray 45. After separation of the transfer paper 48 by the separation charging device 38, the photoreceptor 1 which further rotates continuously is cleaned for the toner or paper dust remaining on the surface by the cleaner 39. The photoreceptor 1 cleaned on the surface by the cleaner 39 is charge-eliminated by a charge elimination lamp (not shown) disposed between the cleaner 39 and the corona charging device 35, and then the image forming operation described above is repeated.

In the image formation of the laser printer 30, since the surface free energy on the surface of the photoreceptor. 1 is set to a preferred range, the toner for forming images are easily transited and transferred from the surface of the photoreceptor 1 onto the transfer paper 48 in which less residual toner occurs and paper dust or the like of the transfer paper put in contact upon transfer is less deposited to the surface of the photoreceptor 1. Accordingly, the polishing performance of the cleaning blade of the cleaner 39 disposed for cleaning the surface of the photoreceptor 1 after transferring the toner images can be set to a weak level and since the pressure of the cleaning blade upon abutment to the surface of the photoreceptor 1 can also be set to a low level, the life of the photoreceptor 1 is extended. Further, since the surface of the photoreceptor 1 is free from the deposition of the obstacles such as the toner or paper dust and always kept clean, images at good quality can be formed stably for a long time. Since the cleaning property is excellent and images can be formed stably for a long time with no deterioration of the quality, and the life of the photoreceptor 1 is long and also a simple cleaner 39 may suffice, an apparatus of a reduced cost and with less frequency of maintenance can be attained.

### EXAMPLE

Examples of the invention are to be described below. At first, descriptions is to be made for photoreceptors provided as examples and comparative examples by forming photosensitive layers under various conditions on a conductive substrate made of aluminum having 30 mm diameter and 340 mm length.

### S1 to S6 Photoreceptors of Example

(S1 photoreceptor): 7 parts by weight of titanium oxide (TTO 55A: manufactured by Ishihara Sangyo Kaisha, Ltd.) and 13 parts by weight of copolymerized nylon (CM 8000: manufactured by Toray Industries, Inc.) were added to a mixed solvent comprising 159 parts by weight of methyl alcohol and 106 parts by weight of 1,3-dioxolane, and put to dispersing treatment by a paint shaker for 8 hours to prepare a coating solution for undercoat layer. The coating solution was filled in the coating tank, to which a conductive substrate was dipped and then pulled up and dried spontaneously to form an undercoat layer of 1 μm thickness.

Then, 1.8 parts by weight of an oxotitanium phthalocyanine crystal of a crystal form showing a maximum diffraction peak at 9.4° and showing diffraction peaks at least at 7.3°, 9.4°, 9.7° and 27.3° in view of the Bragg angle 2θ in the X-ray diffraction spectrum, 1.2 parts by weight of butyral resin (Eslec BM-2, manufactured by Sekisui Chemical Co., Ltd), 0.06 part by weight of polydimethyl siloxane silicone oil (KF-96, manufactured by Shin-Etsu Chemical Co., Ltd.), 77.6 parts by weight of dimethoxyethane, and 19.4 parts by weight of cyclohexanone were mixed and dispersed by a paint shaker to prepare a coating solution for use in a charge generating layer. The coating solution was coated on the undercoat layer described above by the same dip coating method as for the undercoat layer and dried spontaneously to form a charge generating layer of 0.4 μm thickness.

5 parts by weight of a styryl compound represented by the following structural formula (I) as a charge transporting substance, 2.25 parts by weight of a polyester resin (Vylon 290: manufactured by Toyobo Co., Ltd.), 5.25 parts by weight of a polycarbonate resin (G400: manufactured by Idemitsu Kosan Co., Ltd.) and 0.05 part by weight of Smilizer BHT (manufactured by Sumitomo Chemical Co.) were mixed to prepare a coating solution for charge transporting layer using 47 parts by weight of tetrahydrofuran as a solvent. The coating solution was coated over the charge generating layer by the dip coating method, and dried at 110° C. for 1 hour to form a charge transporting layer of 28 μm thickness. The S1 photoreceptor was manufactured as described above.

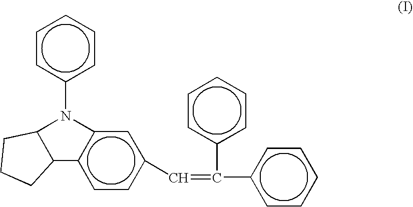

(S2 Photoreceptor); An undercoat layer and a charge generating layer were formed as in the S1 photoreceptor. Subsequently, 5 parts by weight of a butadiene compound represented by the following structural formula (II) as a charge transporting substance, four types of polycarbonate resins, 2.4 parts by weight of J500 (manufactured by Idemitsu Kosan Co., Ltd.), 1.6 parts by weight of G400 (manufactured by Idemitsu Kosan Co., Ltd.), 1.6 parts by weight of GH503 (manufactured by Idemitsu Kosan Co., Ltd.) and 2.4 parts by weight of TS2020 (manufactured by Teijin Kasei K.K.), and 0.25 part by weight of Sumilizer BHT (manufactured by Sumitomo Chemical Co., Ltd.) were mixed, and 49 parts by weight of tetrahydrofuran was used as a solvent to prepare a coating solution for charge transporting layer. This coating solution was coated on a charge generating layer by a dip-coating method, and dried at 130° C. for 1 hour to form a charge transporting layer having a thickness of 28 μm. In this manner, anS2 photoreceptor was produced.

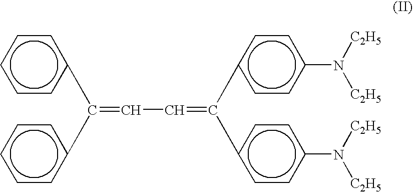

(S3 Photoreceptor); At the time of forming a charge transporting layer, an S3 photoreceptor is manufactured in a similar manner to the S2 photoreceptor, except that 44 parts by weight of GH503 (manufactured by Idemitsu Kosan Co., Ltd.) and 4 parts by weight of TS2020 (manufactured by Teijin Chemicals. Ltd) was used in place of polycarbonate resins.

(S4 Photoreceptor); An undercoat layer and a charge generating layer were formed as in the S1 photoreceptor. Subsequently, 3.5 parts by weight of the butadiene compound represented by the structural formula (II) as a charge transporting substance, 1.5 parts by weight of a styryl compound represented by the following structural formula (III), four types of polycarbonate resins, 2.2 parts by weight of J500 (manufactured by Idemitsu Kosan Co., Ltd.), 2.2 parts by weight of G400 (manufactured by Idemitsu Kosan Co., Ltd.), 1.8 parts by weight of GH503 (manufactured by Idemitsu Kosan Co., Ltd.) and 1.8 parts by weight of TS2020 (manufactured by Teijin Kasei K. K.), and 1.5 parts by weight of Sumilizer BHT (manufactured by Sumitomo Chemical Co., Ltd.) were mixed, and 55 parts by weight of tetrahydrofuran was used as a solvent to prepare a coating solution for charge transporting layer. This coating solution was coated on a charge generating layer by a dip-coating method, and dried at 120° C. for 1 hour to form a charge transporting layer having a thickness of 28 μm. In this manner, the S4 photoreceptor was produced.

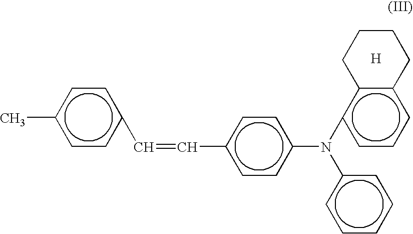

(S5 and S6 Photoreceptors); An undercoat layer and a charge generating layer were formed as in the S1 photoreceptor. Subsequently, a coating solution was prepared as in the S2 photoreceptor except that PTFE, a resin having a low surface free energy (γ) was used in place of a part of polycarbonate resins in forming a charge transporting layer. This coating solution was coated on the charge generating layer by a dip-coating method, and dried at 120° C. for 1 hour to form a charge transporting layer having a thickness of 28 μm. The photoreceptors were produced respectively such that the content of PTFE occupied in the coating solution for forming a charge transporting layer was higher in an S5 photoreceptor than in an S6 photoreceptor and γ of the photoreceptor in the S5 photoreceptor was lower than γ of the photoreceptor in the S6 photoreceptor.

### R1 to R6 Photoreceptors of Comparative Examples

(R1 Photoreceptor); In a similar manner to the S1 photoreceptor, an undercoat layer and an charge generating layer are formed. Thereafter, a coating solution for charge transporting layer is formulated by mixing 5 parts by weight of butadiene compound expressed by the above-described structural formula (II) as a charge transporting substance, two types of polycarbonate resin, i.e., 2.4 parts by weight of G400 (manufactured by Idemitsu Kosan Co., Ltd.), and 4 parts by weight of TS2020 (manufactured by Teijin Chemicals. Ltd.), 1.6 parts by weight of polyester resin Vylon290 (manufactured by Toyobo Co., Ltd.), and 0.25 part by weight of Sumilizer BHT (manufactured by Sumitomo Chemical Co. Ltd.). Herein, 49 parts by weight of tetrahydrofuran is used as solvent. The resulting coating solution is coated on the charge generating layer by immersion coating, and then the coated result is dried at 130° C. for 1 hour so that a charge transporting layer having the layer thickness of 28 μm is formed. In such a manner, an R1 photoreceptor is manufactured.

(R2 Photoreceptor); In a similar manner to the R1 photoreceptor, an undercoat layer and a charge generating layer are formed. Thereafter, a coating solution for charge transporting layer is formulated by mixing 5 parts by weight of butadiene compound expressed by the above-described structural formula (II) as a charge transporting substance, two types of polycarbonate resin, i.e., 4.4 parts by weight of two kinds of polycarbonate resins J500 (manufactured by Idemitsu Kosan Co., Ltd.), 3.6 parts by weight of TS2020 (manufactured by Teijin Chemicals Ltd.) and, further, 0.25 part by weight of sumilizer BHT (manufactured by Sumitomo Chemical Co., Ltd.) were mixed to prepare a coating solution for charge transporting layer using 49 parts by weight of tetrahydrofuran as a solvent. The coating solution was coated on the charge generating layer by a dip-coating method, and dried at 120° C. for 1 hour to form a charge transporting layer of 28 μm thickness. The R2 photoreceptor was manufactured as described above.

(R3 Photoreceptor); A photoreceptor in R3 Photoreceptor was produced as in the R2 Photoreceptor except that 4.4 parts by weight of J500 (manufactured by Idemitsu Kosan Co., Ltd.) was replaced with G400 (manufactured by Idemitsu Kosan Co., Ltd.) as a polycarbonate resin in the formation of a charge transporting layer.

(R4 Photoreceptor); An undercoat layer and a charge generating layer were formed as in the R1. Subsequently, in the formation of a charge transporting layer, a coating solution was prepared as in the R1 photoreceptor except that PTFE, a resin having low γ was used instead of a part of polycarbonate resins. This coating solution was coated on the charge generating layer by a dip-coating method, and dried at 120° C. for 1 hour to form a charge transporting layer having a thickness of 28 μm. In this manner, an R4 photoreceptor was produced.

(R5 photoreceptor): R5 photoreceptor was manufactured in the same manner as for S1 photoreceptor except for replacing the charge generating substance to an X-type non-metal phthalocyanine (Fastogen Blue 8120BS, manufactured by Dainippon Ink and Chemicals, Incorporated) upon forming the charge generating layer.

(R6 photoreceptor): R6 photoreceptor was manufactured in the same manner as S1 photoreceptor except for replacing the charge generating substance with a so-called α-type oxotitanium phthalocyanine showing peaks at 7.5°, 12.3°, 16.3°, 25.3°, and 28.7° in view of Bragg angle 2θ in the X-ray refraction spectrum upon forming the charge generating layer.

As described in the foregoing, at the time of manufacturing photoreceptors S1 to S6 of the examples and photoreceptors R1 to R6 of the comparative examples, a resin type and a content ratio contained in the coating solution for charge transporting layer are changed, and the drying temperature after coating is changed to adjust the surface free energy (γ) on the surfaces of those photoreceptors to be any desired value. γ of the surfaces of those photoreceptors is measured by using a contact angle measurement device CA-X (manufactured by Kyowa Interface Science Co., Ltd.), and analytical software EG-11 (manufactured by Kyowa Interface Science Co., Ltd.)

S1 to S6 photoreceptors of the examples and R1 to R6 photoreceptors of the comparative examples were mounted respectively to a digital copying machine AR-450 (manufactured by Sharp Corp.) modified for testing and images were formed to conduct evaluation tests for sensitivity, cleaning property, stability of image quality, quietness, and surface roughness (evaluation test)). Then, the evaluation method for each of the performances is to be described below.

[Cleaning Performance]

A cleaning blade of a cleaner provided to the above digital copying machine AR-450 is so adjusted that the abutment pressure of abutting on a photoreceptor, i.e., cleaning blade pressure, is of 21 gf/cm with the initial line voltage. Under the environment of temperature: 25° C., and relative humidity: 50%, using the above copying machine, a character test original with printing rate 6% is copied on 100,000 sheets of test paper SF-4AM3 (manufactured by Sharp Corp).

In this example, the character test document and the test paper were used in common. By observing images formed before forming images (before test) and after 100,000 sheets of test, the formed images are subjected to visual observations to check the image sharpness of boundary portion between two colors of black and white, and whether there is any black streak resulted from toner leakage in the direction along which the photoreceptor rotates. Thereafter, a measurement device, which will be described later, is used to calculate a fog amount (Wk) so that the cleaning performance is evaluated. The fog amount Wk of the formed images is calculated by measuring the reflection density using the Z-Σ90 COLOR MEASURING SYSTEM manufactured by Nippon Denshoku Industries, Co., Ltd. First of all, an average reflection density Wr is measured for recording paper before image formation. Then, an image is formed on the recording paper, and after the image is formed thereon, white portions of the recording paper are each subjected to measurement for the reflection density. In the following expression of {100×(Wr−Ws)/Wr}, where Ws denotes the reflection density of the portion determined that the fogging is most obvious, i.e., the white portion showing the highest density, and Wk denotes as above, the calculation result is defined as the fog amount.

The criterion for evaluating the cleaning performance is as follows:

AA: Quite satisfactory. Clear sharpness and no black streak. Fog amount Wk of less than 3%.

A: Satisfactory. Clear sharpness and no black streak. Fog amount Wk of 3% or more but less than 5%.

B: Practically no problem. Sharpness of practically-no-problem level, and 5 or less black streaks of 2.0 mm or shorter. Fog amount Wk of 5% or more but less than 10%.

C: No good for practical use. Questionable on sharpness for practical use. Black streaks exceeding the range for “B”. Fog amount Wk of 10% or more.

[Stability of Image Quality]

In the same manner as the evaluation for the cleaning property described above, a 100,000 sheet test was conducted and an evaluation test for the stability of the image quality was conducted by measuring the reflection density at the printed area of the test paper before image formation (before test) and after the 100,000 test by using Machbes RD 918, manufactured by Sakata Inx Corporation, ΔD determined according to the following equation (Dr−Ds=ΔD) based on the reflection density Dr and the specified aimed minimum reflection density Ds was defined as an image density guaranteed level and the stability of the image quality was evaluated depending on the image density guaranteed level ΔD. The evaluation standards for the stability of the image quality is as described below.

AA: Excellent. ΔD is 0.3 or more.

A: Good. ΔD is 0.1 or more and less than 0.3.

B: Somewhat poor. ΔD is −0.2 or more and less than 0.1.

C: Poor. ΔD is larger than −0.2 in the minus direction.

[Quietness]

Using a copying machine put to initial setting to the same cleaning blade pressure as that for the evaluation of the cleaning property, a character test original document was formed to 100,000 sheets of test paper under a high temperature/high humidity circumstance at a temperature of 35° C. and a relative humidity of 85%. Before image formation (before testing) and after the 100,000 sheet test, presence or absence of abnormal vibration sounds caused by friction between the photoreceptor and the cleaning blade, so-called “squeaking” was detected by operator's hearing.

The standard criteria for the quietness are as described below.

AA: Excellent. No squeaking.

A: Good. Squeaking occurs only at the start or the end of the rotation of the photoreceptor.

B: Somewhat poor. Squeaking both at the start and the completion of the rotation of the photoreceptor.

C: Poor. Continuous squeaking during rotation of the photoreceptor.

[Surface Roughness]

Images were formed by 100,000 sheets under the same conditions as those in the evaluation test for the cleaning property described above and, after the completion of image formation, the maximum height Rmax according to Japanese Industrial Standards (JIS) B 0601 for the surface of the photoreceptor was measured by using Surf Com 570A manufactured by Tokyo Seimitsu Co. Ltd.

It was judged that the durability was more excellent as the maximum height Rmax was smaller after the completion of image formation.

[Result of Evaluation]

All the result of the evaluation are shown in Table 1 together. All of S1 to S6 photoreceptors of the examples and R5, R6 photoreceptors of the comparative examples with γ being in the range of the invention showed the test result that the cleaning property was good (A) or superior. Particularly, S1 to S4 photoreceptors with y being in the range from 28 to 35 mN/m showed excellent (AA) cleaning property.

On the other hand, in R4 photoreceptor of the comparative example with γ being less than the range of the invention, disadvantage due to the decrease of the deposition strength of the toner or the like to the photoreceptor is remarkable. On one hand, transfer ratio is improved along with decrease of the deposition strength of the toner or the like to the photoreceptor, to decrease the residual toner directing to the cleaning blade. As a result, turning of the blade or blade skip marks to the photoreceptor were caused to result in degradation of the image quality. Further, toner scattering was promoted along with decrease of the deposition strength and effects by the scattered toner was observed on the surface or the rear face of the recording paper. As a result, black streaks or fogging tend to occur to worsen the cleaning property. Further, in R1 to R3 photoreceptors of the comparative example with the γ being larger than the range of the invention, since the toner or the paper dust was caught to the cleaning blade to injure the surface of the photoreceptor along with increase of γ, the cleaning property was worsened due to the flaws caused to the surface of the photoreceptor.

Then, in the evaluation for the stability of the image quality, that is, the guaranteed level for the image density ΔD, sufficient image density was obtained for the S1 to S6 photoreceptors of the example before and after the test and evaluation was excellent (AA: ΔD is 0.3 or more) for each of them. While ΔD of R2, R3 photoreceptors among R1 to R4 photoreceptors of the comparative examples was excellent (AA) respectively before the test, degradation was recognized after the test. R2 photoreceptor was good (A: ΔD is 0.1 or more and less than 0.3), and R3 receptor was somewhat poor (B: ΔD is −0.2 or more and less than 0.1). It is considered that since γ of the photoreceptor was large, the maximum height Rmax on the surface of the photoreceptor after the test was large, that is, the surface roughness increased due to flaws, etc. and the laser light for forming the images caused random reflection at the surface of the photoreceptor and no sufficient amount of light could be obtained to worsen the sensitivity.

Further, in R5 photoreceptor of the comparative example, since the X-type non-metal phthalocyanine was used as the charge generating substance, the sensitivity was extremely poor and the specified aimed minimum reflection density Ds was remarkably poor before and after the test. Further, in R6 photoreceptor of the comparative example, since a so-called α-type oxotitanium phthalocyanine showing peaks at 7.5°, 12.3°, 16.3°, 25.3°, 28.7° in view of Bragg angle 2θ in the X-ray refraction spectrum as the charge generating substance was used, and the stability for the long time was poor than that of the oxotitanium phthalocyanine according to the invention, while it was good (A: ΔD is 0.1 or more and less than 0.3) before the test, the result after the test was somewhat poor for the image density guaranteed level (B: ΔD is −0.2 or more and less than 0.1).

Then, as a result of detection and evaluation for the quietness, that is, squeaking for all S1 to S6 photoreceptors of the invention and R1 to R6 photoreceptors of the comparative examples, it has been found that occurrence of “squeaking” tended to increase along with increase of γ, to worsen the quietness.

As a result of measuring the maximum height Rmax on the surface of the photoreceptor after the completion of image formation for 100,000 sheets, it can be seen that the maximum height Rmax was large and the surface roughness increased more in R1 to R3 photoreceptors of the comparative examples compared with S1 to S6 photoreceptors of the examples and R4 to R6 photoreceptors of the comparative example. In R1 to R3 photoreceptors of the comparative examples, γ was large exceeding the range of the invention and the surface roughness tended to increase remarkably along with increase of γ. In view of the above, it was confirmed that deposition strength of obstacles to the surface of the photoreceptor increased along with increase of γ to roughen the surface roughness due to flaws caused by deposited obstacles.

TABLE 1

| | | | | | | | | | Surface |
|---|---|---|---|---|---|---|---|---|---|
| | | | | | | | | | Roughness |
| | | | | | | | | | Rmax |
| | | | Cleaning property | | Image stability | | Quietness | | (μm) |
| | | | | After | | After | | After | After |
| | | Y | | 100,000 | | 100,000 | | 100,000 | 100,000 |
| | Photoreceptor | (mN/m) | Initial | sheets | Initial | sheets | Initial | sheets | sheets |
| Example | S5 | 22.0 | AA | A | AA | AA | AA | AA | 0.63 |
| | S6 | 25.1 | AA | A | AA | AA | AA | A | 0.50 |
| | S1 | 28.3 | AA | AA | AA | AA | A | B | 0.49 |
| | S2 | 30.5 | AA | AA | AA | AA | A | B | 0.47 |
| | S3 | 33.0 | AA | AA | AA | AA | A | B | 0.55 |
| | S4 | 34.8 | AA | AA | AA | AA | A | B | 0.48 |
| Comp. | R4 | 19.8 | B | C | AA | AA | AA | AA | 0.70 |
| Example | R5 | 28.4 | AA | AA | C | C | A | B | 0.51 |
| | R6 | 28.3 | AA | AA | A | B | A | B | 0.48 |
| | R1 | 36.0 | PA | B | PA | AA | B | C | 0.90 |
| | R2 | 40.5 | A | C | PA | A | C | C | 1.63 |
| | R3 | 44.3 | B | C | PA | B | C | C | 2.01 |

As has been described above, the laser printer 30 as an image forming apparatus in this embodiment is not restricted to the constitution shown in FIG. 5 but it may be of any other different constitution so long as the photoreceptor according to the invention can be used.

For example, in a case where the outer diameter of the photoreceptor is 40 mm or less, the separating charging device 38 may not be provided. Further, the photoreceptor 1 may be constituted integrally with at least one of the corona charging device 35, the developing device 36 and the cleaner 39 to form a process cartridge. For example, it can adopt a constitution, for example, of a process cartridge in which the photoreceptor 1, corona charging device 35 and the developing device 36 and a cleaner 39 are incorporated, a process cartridge where the photoreceptor 1, the corona discharging device 35 and the developing device 36 are incorporated, a process cartridge in which the photoreceptor 1 and the cleaner 39 are assembled, or a process cartridge in which the photoreceptor 1 and the developing device 36 are assembled. By using the process cartridge, in which the members are integrated, the maintenance and the control for the apparatus are facilitated.

Further, the charging device is not restricted to the corona charging device 35 but a corotron discharging device, scorotron charging device, saw teeth charging device, or roller charging device can also be used. For the developing device 36, at least either one of contact type and non-contact type maybe used. As the cleaner 39, a cleaning blade or brush cleaner may also be used. A constitution saving the charge elimination lamp may also be adopted by devising a timing at which a high voltage such as a developing bias is applied. Particularly, this is often saved in those having a photoreceptor with small diameter, a low temperature low end printer, etc.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

### INDUSTRIAL APPLICABILITY

According to the invention, the photosensitive layer of the photographic photoreceptor contains an oxotitanium phthalocyanine of a crystal form showing diffraction peak at least at 27.3° in view of the Bragg angle 2θ in the X-ray refraction spectrum and the surface free energy (γ) on the surface thereof is set to range from no less than 20 mN/m to no more than 35 mN/m and, preferably, from no less than 28 mN/m to no more than 35 mN/m.

The surface free energy on the surface of the electrophotographic photoreceptor is an index of wettability, that is, the deposition strength, for example, of the developer or paper dust relative to the surface of the electrophotographic photoreceptor. By setting the surface free energy within the preferred range described above, since excess deposition strength can be suppressed particularly for the developer irrespective of onset of deposition strength about at a level necessary for development and the strength of the obstacles such as paper dust can be suppressed, excessive developer and obstacles tend to be moved easily from the surface of the electrophotographic photoreceptor. As described above, the cleaning property can be improved without deteriorating the developing performance. Accordingly, since flaws due to obstacles deposited on the surface are less caused, an electrophotographic photoreceptor of excellent durability of long life and not causing deterioration of the quality in the formed images stably for a long time can be attained.

Further, since the oxotitanium phthalocyanine of the crystal form contained in the photosensitive layer showing a refraction peak at least at 27.3° in view of the Bragg angle 2θ in the X-ray diffraction spectrum has an extremely high charge generating ability to a near infrared light at 780 nm or 660 nm which is an oscillation wavelength of light of a laser or an LED serving as optical input means suitable for formation of digital images, or for a long wavelength light approximate thereto, an electrophotographic photoreceptor of high sensitivity, high resolution and high image quality can be attained. As described above according to the invention, it is possible to provide an electrophotographic photoreceptor capable of satisfying both the cleaning property and the high sensitivity characteristics.

Further, according to the invention, by using an oxotitanium phthalocyanine of the crystal form showing a maximum diffraction peak at 9.4°, or 9.7° and showing diffraction peaks at least at 7.3°, 9.4°, 9.7°, and 27.3° in view of the Bragg angle 2θ in the X-ray diffraction spectrum for the electrophotographic photoreceptor, the sensitivity can be improved, as well as images at high quality can be provided. Further, it is possible to attain an electrophotographic photoreceptor excellent in the potential stability to the repetitive use, with extremely less occurrence of background fogging in the electrophotographic process using reversal development, and having extremely high sensitivity in a long wavelength region and high durability.

Further, according to the invention, the photosensitive layer of the electrophotographic photoreceptor is constituted by laminating the charge generating layer containing the charge generating substance and the charge transporting layer containing the charge transporting substance. By forming the photosensitive layer to a type in which a plurality of photosensitive layers are laminated, since the degree of freedom increases for the materials constituting each of the layers and the combination thereof, values for the surface free energy on the surface of the electrophotographic photoreceptor can be easily set to a desired range.

Further, according to the invention, an electrophotographic photoreceptor of excellent cleaning property and having high sensitivity is provided in the image forming apparatus. Accordingly, an image forming apparatus capable of forming images with no degradation of images quality for a long time, at a reduced cost and with less frequency for maintenance is provided.

1. An electrophotographic photoreceptor comprising:
a conductive substrate; and
a photosensitive layer provided on the conductive substrate, the photosensitive layer being uniformly charged with electric charges and exposed to light in accordance with image information to form electrostatic latent images,
wherein the photosensitive layer contains an oxotitanium phthalocyanine of a crystal form showing a diffraction peak at least at 27.3° in view of the Bragg angle 2θ in the X-ray diffraction spectrum and a surface free energy (γ) on a surface thereof ranges from no less than 20 mN/m to no more than 35 mN/m.

2. The electrophotographic photoreceptor of claim 1, wherein the surface free energy (γ) ranges form no less than 28 mN/m to no more than 35 mN/m.

3. The electrophotographic photoreceptor of claim 1, wherein the oxotitanium phthalocyanine is an oxotitanium phthalocyanine of a crystal form showing the maximum diffraction peak at 9.4° or 9.7° and having diffraction peaks at least at 7.3°, 9.4°, 9.7°, and 27.3° in view of the Bragg angle 2θ in the X-ray diffraction spectrum.

4. The electrophotographic photoreceptor of claim 1, wherein the photosensitive layer is formed by laminating a charge generating layer containing a charge generating substance and a charge transporting layer containing a charge transporting substance.

5. An image forming apparatus comprising the electrophotographic photoreceptor of claim 1.
